(19) United States
(12) Patent Application Publication
(10) Pub. No.: US 2023/0327864 A1
(43) Pub. Date: Oct. 12, 2023

(54) APPARATUSES, METHODS, AND COMPUTER-READABLE MEDIA FOR GENERATING AND UTILIZING A PHYSICAL UNCLONABLE FUNCTION KEY

(71) Applicant: HUAWEI TECHNOLOGIES CO., LTD., Shenzhen (CN)

(72) Inventors: Dongxu Ma, Kitchener (CA); Mikhail Kazaev, Waterloo (CA); Zhijun Mo, Waterloo (CA)

(21) Appl. No.: 17/718,576

(22) Filed: Apr. 12, 2022

(51) Int. Cl. H04L 9/08; H04L 9/32

(52) U.S. Cl. CPC H04L 9/0866; H04L 9/085; H04L 9/3263

(57) ABSTRACT

There is described methods and devices for generating and utilizing a physical unclonable function (PUF) key. A hardware source is read to obtain a hardware output of a unique identifier of the hardware source. One of a plurality of hardware PUF methods is selected, each of the plurality of hardware PUF methods adapted to a respective hardware source type. The PUF key is generated from the hardware output using the selected hardware PUF method.

### RELATED APPLICATIONS

This is the first patent application pertaining to the disclosed technology.

### FIELD

The present disclosure relates to methods, computer-readable media, and computing devices for data security and encryption, and more specifically for generating a physical unclonable function key.

### BACKGROUND

Data encryption is a commonly used data security technology to protect data. Data encryption uses cryptographic algorithms and encryption keys to encrypt data into cipher text data. The security of the encrypted data depends on the confidentiality of the encryption key. Traditional systems use a hardware root of trust to maintain the confidentiality of the encryption key. Examples of traditional hardware roots of trust include Trusted Platform Modules (TPM), Hardware Security Modules (HSM), and Trusted Execution Environments (TEE). A TPM chip is a secure crypto-processor that is designed to carry out cryptographic operations. An HSM is a physical computing device (which may be an external device) containing a secure crypto-processor that safeguards keys and performs encryption. A TEE is a secure area of a main processor. The encryption key in the hardware root of trust cannot be read or tampered with, thereby ensuring the security of the encrypted data.

### SUMMARY

Generally according to embodiments of the disclosure, there are described methods for securely storing and communicating data. Traditional methods for securely storing data make use of a hardware root of trust. There are a number of well-know problems with a traditional hardware roots of trust such as TEE, HSM, and TPM. The deployment costs of a hardware root of trust are relatively high. Low-end or old hardware platforms do not support a hardware root of trust. Cloud technologies often make use of heterogeneous hardware platforms. The different hardware platforms in the cloud may make use of different kinds of hardware roots of trust or may not support any kind of hardware root of trust. It is therefore difficult to make use of traditional hardware roots of trust to protect data in the cloud with heterogeneous hardware platforms. Hardware roots of trust are not well suited to container orchestration technologies, such as Kubernetes. Container orchestration technologies automatically distribute the storage and processing of data throughout the hardware platforms in the cloud. Traditional secret storage technology based on a hardware root of trust is bound to a specific hardware device. Once the container orchestration technology schedules the data to another hardware device, the secret data can no longer be accessed.

In particular, according to embodiments of the disclosure, there are described methods for securely storing data without a hardware root of trust. These methods enable the secure storage of data without the many disadvantages of a hardware root of trust. A hardware source, such as memory or a processor, provides a physical unclonable function (PUF) to generate a unique hardware output. A PUF is a physical function of a hardware source that given an input provides a physically determined output unique to the hardware source. PUFs may be based on unique physical variations that arise during manufacturing. The unique hardware output is unique to the hardware source because the unique hardware output results from random physical factors in the microstructure of the hardware source that arise naturally during manufacturing. The unique hardware output may be for example the initial power-on value of memory. A library is used to generate a hardware PUF value based on the unique hardware output. The library comprises a plurality of methods for calculating the hardware PUF value based on the unique hardware output. Each of the methods is adapted for different types of hardware sources. The library selects the method based on the type of the hardware source. Consequently, the library may be used on a variety of different hardware. The hardware PUF value is used to generate one or more encryption keys. The encryption keys may comprise a symmetric key and asymmetric keys, including private and public keys. The symmetric key may be used to securely store data locally on a local storage device. The asymmetric key may be used to communicate securely with remote computers. The PUF encryption may be combined with a secret sharing group to increase the security of the stored data. In particular, this PUF encryption may be used to establish a secret sharing group on heterogeneous hardware because the library can adapt to different hardware sources.

According to a first aspect of the disclosure, there is described a method for generating a physical unclonable function (PUF) key, comprising: obtaining a hardware output of a unique identifier of a hardware source by reading the hardware source; selecting one of a plurality of hardware PUF methods, each of the plurality of hardware PUF methods adapted to a respective hardware source type; and generating the PUF key based on the hardware output using the selected hardware PUF method.

In an example of the preceding aspect of the method, the method further comprises detecting a hardware type of the hardware source, wherein the selected hardware PUF method may be selected based on the hardware type. An indication of the hardware type may be stored in a mapping table. The selected hardware PUF method may be selected based on an error rate of the hardware type, wherein the error rate of the hardware type is stored in the mapping table. The plurality of hardware PUF methods may comprise a first hardware PUF method with an error tolerance of less than 10%, a second hardware PUF method with an error tolerance of less than 20%, a third hardware PUF method with an error tolerance of less than 30%, and a fourth hardware PUF method with an error tolerance of less than 40%. The selected hardware PUF method may be the fourth hardware PUF method if the hardware type is not detected or known. Alternatively, the selected hardware PUF method is selected by a user, for example in a configuration or settings file.

In an example of any of the preceding aspects of the method, the hardware source may be a static random-access memory (SRAM), a dynamic random-access memory (DRAM), a field programmable gate array (FPGA), an ARM processor, an X86 processor, a RISC processor, a graphics processing unit (GPU), a data processing unit (DPU), a neural-network processing unit (NPU), a microcontroller unit (MCU), a system on a chip, an application specific integrated circuit, or other programmable circuit. The hardware source may be internal to a computer device or external to the computer device.

In an example of any of the preceding aspects of the method, the hardware output may be an initial power-on value of the hardware source. For example, the hardware output may be the initial power-on value of SRAM or DRAM.

In an example of any of the preceding aspects of the method, the method may further comprise passing the PUF key to a key management service, such as a keyring. The PUF key may be stored securely in a keyring. The PUF key may comprise a PUF symmetric key and a PUF asymmetric key, wherein the PUF asymmetric key may comprise a public key and a private key. The method may further comprise using the PUF symmetric key to securely store local user data. The PUF symmetric key may be used to encrypt data before it is stored on a storage device. The method may further comprise using the PUF asymmetric key to securely communicate with a remote computer on a computer network.

In an example of any of the preceding aspects of the method, the method may further comprise using the PUF asymmetric key to join a secret sharing group comprising a plurality of computers. The method may further comprise encrypting data, by a first computer in the secret sharing group, using an encryption key. The method may further comprise splitting, by the first computer in the secret sharing group, the encryption key using a secret sharing method into a plurality of encryption key parts. The method may further comprise sending, by the first computer, the encryption key parts to at least one of the plurality of computers in the secret sharing group. The method may comprise encrypting, by the at least one other computer of the plurality of computers in the secret sharing group, the encryption key part using the PUF symmetric key. The method may comprise decrypting, by the at least one other computer of the plurality of computers in the secret sharing group, the encryption key part using the PUF symmetric key. The method may comprise retrieving, by the first computer, one or more of the plurality of encryption key parts from the plurality of computers in the secret sharing group. The method may comprise combining, by the first computer, the encryption key parts to recover the encryption key using the secret sharing method. The method may comprise decrypting, by the first computer, the data using the encryption key. The first computer may send m encryption key parts, and the first computer may retrieve n encryption key parts, where n is less than m, and where n is greater than a minimum threshold required to recover the encryption key using the secret sharing method.

In an example of any of the preceding aspects of the method, the method may comprise receiving an encryption key part from a remote computer of the plurality of computers in the secret sharing group; encrypting the encryption key part using the PUF symmetric key; receiving a request for the encryption key part from the remote computer; decrypting the encryption key part using the PUF symmetric key; and sending the encryption key part to the remote computer.

In an example of any of the preceding aspects of the method, the method may comprise generating a device certificate for device authentication using the PUF asymmetric key.

According to a further aspect of the disclosure, there is provided a non-transitory computer-readable medium comprising computer program code stored thereon for generating a physical unclonable function (PUF) key, wherein the code, when executed by one or more processors, causes the one or more processors to perform a method comprising: obtaining a hardware output of a unique identifier of a hardware source by reading the hardware source; selecting one of a plurality of hardware PUF methods, each of the plurality of hardware PUF methods adapted to a respective hardware source type; and generating the PUF key based on the hardware output using the selected hardware PUF method.

The method may furthermore comprise performing any of the operations described above in connection with the first aspect of the disclosure.

According to a further aspect of the disclosure, there is provided a computing device comprising one or more processors operable to perform a method for generating a physical unclonable function (PUF) key, wherein the method comprises obtaining a hardware output of a unique identifier of a hardware source by reading the hardware source; selecting one of a plurality of hardware PUF methods, each of the plurality of hardware PUF methods adapted to a respective hardware source type; and generating the PUF key based on the hardware output using the selected hardware PUF method.

The method may furthermore comprise performing any of the operations described above in connection with the first aspect of the disclosure.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of a computer network system for data sharing, according to some embodiments of the present disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing a system for generating a hardware PUF key, according to some embodiments of the present disclosure;

FIG. 5 is a schematic diagram showing an adaptive hardware PUF library, according to some embodiments of the present disclosure; and

FIG. 6 is a schematic diagram showing a secret sharing group, according to some embodiments of the present disclosure.

### DETAILED DESCRIPTION

The present disclosure relates to methods, computer-readable storage media, and computing devices for generating a physical unclonable function (PUF) key. While various embodiments of the disclosure are described below, the disclosure is not limited to these embodiments, and variations of these embodiments may well fall within the scope of the disclosure.

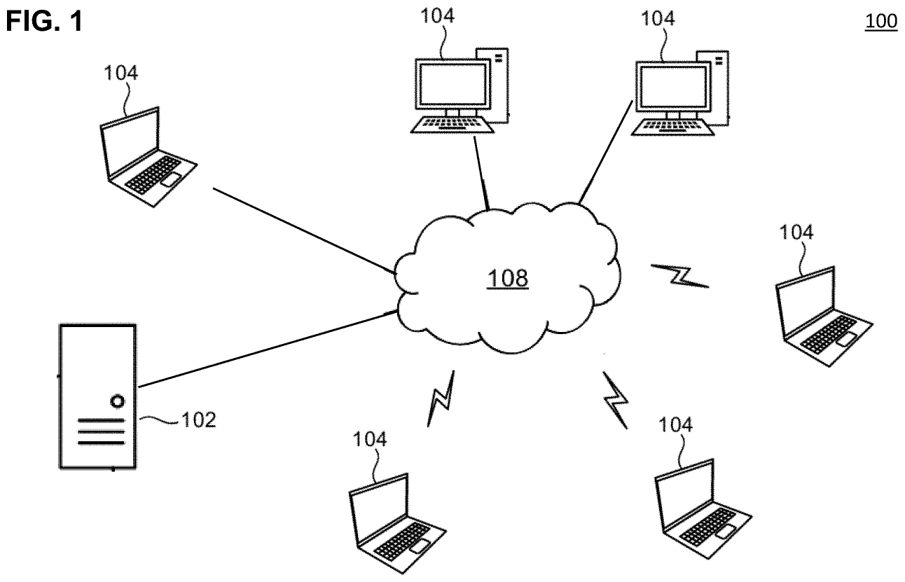

Turning now to FIG. 1, a computer network system for data sharing is shown and is generally identified using reference numeral 100. As shown, the computer network system 100 comprises one or more server computers 102 and a plurality of client computing devices 104 functionally interconnected by a network 108, such as the Internet, a local area network (LAN), a wide area network (WAN), a metropolitan area network (MAN), and/or the like, via suitable wired and/or wireless networking connections.

The server computers 102 may be computing devices designed specifically for use as a server, and/or general-purpose computing devices acting as server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

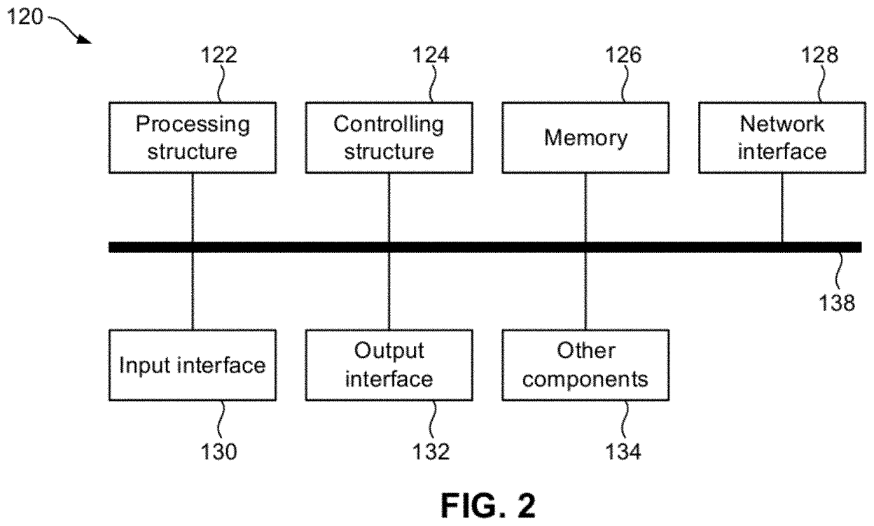

Generally, the computing devices including server computer 102 and client computing devices 104 have a similar hardware structure such as a hardware structure 120 shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), p-controllers (UCs), specialized/customized processors and/or controllers using, for example, field-programmable gate array (FPGA) or application-specific integrated circuit (ASIC) technologies, and/or the like.

Generally, each processor of the processing structure 122 comprises necessary circuitries implemented using technologies such as electrical and/or optical hardware components for executing one or more processes as the implementation purpose and/or the use case maybe, to perform various tasks.

For example, each processor of the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation” or more generally, “processing”, for generating or producing the outputs from the inputs thereof.

Sophisticated combinations of logic gates in the form of a circuitry of logic gates, such as the one or more processors of the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed tasks. In this example, the tasks thereof are “hard-coded” in the circuitry.

With the advance of technologies, it is often that a circuitry of logic gates, such as the one or more processors of the processing structure 122, may be alternatively designed in a general manner so that it may perform various tasks according to a set of “programmed” instructions implemented as firmware and/or software and stored in one or more non-transitory computer-readable storage devices or media. In this example, the circuitry of logic gates, such as the one or more processors of the processing structure 122, is usually of no use without meaningful firmware and/or software.

Of course, those skilled the art will appreciate that a processor may be implemented using other technologies such as analog technologies.

The controlling structure 124 comprises one or more controlling circuits, such as graphic controllers, input/output chipsets, and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided into a plurality of portions for different use purposes. For example, a portion of the memory 126 (denoted as storage memory herein) may be used for long-term data storing, for example, for storing files or databases. Another portion of the memory 126 may be used as the system memory for storing data during processing (denoted as working memory herein).

The network interface 128 comprises one or more network modules for connecting to other computing devices or networks through the network 108 by using suitable wired and/or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screens, touch-sensitive whiteboards, touch-pads, keyboards, computer nice, trackballs, microphones, scanners, cameras, and/or the like. The input interface 130 may be a physically integrated part of the computing device 102/104 (for example, the touch-pad of a laptop computer or the touch-sensitive screen of a tablet), or may be a device physically separated from but functionally coupled to, other components of the computing device 102/104 (for example, a computer mouse). The input interface 130, in some implementation, may be integrated with a display output to form a touch-sensitive screen or a touch-sensitive whiteboard.

The output interface 132 comprises one or more output modules for output data to a user. Examples of the output modules include displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or a tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement units (IMUs), and/or the like. Examples of the positioning modules may be one or more global navigation satellite system (GNSS) components (for example, one or more components for operation with the Global Positioning System (GPS) of USA, Global'naya Navigatsionnaya Sputnikovaya Sistema (GLONASS) of Russia, the Galileo positioning system of the European Union, and/or the Beidou system of China).

The system bus 138 interconnects various components 122 to 134 enabling them to transmit and receive data and control signals to and from each other.

From the computer point of view, the computing device 102/104 may comprise a plurality of modules. Herein, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As a part of a device, an apparatus, a system, and/or the like, a module may be coupled to or integrated with other parts of the device, apparatus, or system such that the combination thereof forms the device, apparatus, or system. Alternatively, the module may be implemented as a standalone device or apparatus.

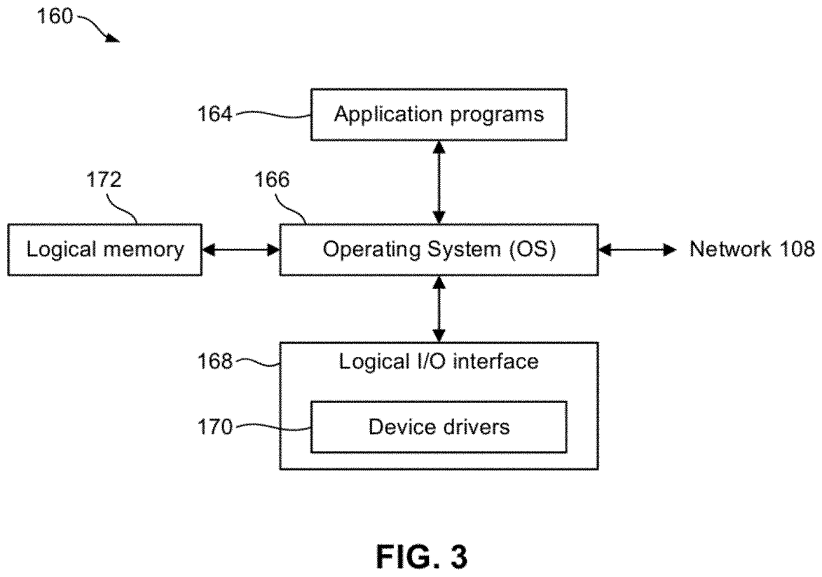

FIG. 3 shows a simplified software architecture 160 of the computing device 102 or 104. The software architecture 160 comprises an application layer, an operating system 166, a logical input/output (I/O) interface 168, and a logical memory 172. The application layer, operating system 166, and logical I/O interface 168 are generally implemented as computer-executable instructions or code in the form of software programs or firmware programs stored in the logical memory 172 which may be executed by the processing structure 122.

Herein, a software or firmware program is a set of computer-executable instructions or code stored in one or more non-transitory computer-readable storage devices or media such as the memory 126, and may be read and executed by the processing structure 122 and/or other suitable components of the computing device 102/104 for performing one or more processes. Those skilled in the art will appreciate that a program may be implemented as either software or firmware, depending on the design purposes and requirements. Therefore, for ease of description, the terms “software” and “firmware” may be interchangeably used hereinafter.

Herein, a process has a general meaning equivalent to that of a method, and does not necessarily correspond to the concept of computing process (which is the instance of a computer program being executed). More specifically, a process herein is a defined method implemented as software or firmware programs executable by hardware components for processing data (such as data received from users, other computing devices, other components of the computing device 102/104, and/or the like). A process may comprise or use one or more functions for processing data as designed. Herein, a function is a defined sub-process or sub-method for computing, calculating, or otherwise processing input data in a defined manner and generating or otherwise producing output data.

Alternatively, a process may be implemented as one or more hardware structures having necessary electrical and/or optical components, circuits, logic gates, integrated circuit (IC) chips, and/or the like.

Referring back to FIG. 3, the application layer comprises one or more application programs 164 executed by or performed by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow the application programs 164 to communicate with programs running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google Inc., Mountain View, CA, USA), or the like. The computing devices 102 and 104 of the computer network system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the application layer for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations, volatile physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the application layer generally comprises one or more server-side application programs 164 which provide(s) server functions for managing network communication with client computing devices 104 and facilitating collaboration between the server computer 102 and the client computing devices 104. Herein, the term “server” may refer to a server computer 102 from a hardware point of view, or to a logical server from a software point of view, depending on the context.

As described above, the processing structure 122 is usually of no use without meaningful firmware and/or software. Similarly, while a computer system 100 may have the potential to perform various tasks, it cannot perform any tasks and is of no use without meaningful firmware and/or software. As will be described in more detail later, the computer system 100 described herein, as a combination of hardware and software generally produce tangible results tied to the physical world, wherein the tangible results such as those described herein may lead to improvements to the computer and system themselves.

The following embodiments may all be implemented on an electronic device (for example, computing device 102 or 104) with the foregoing hardware structure.

There are a number of well-know problems with a traditional hardware root of trust such as TEE, HSM, and TPM. The deployment costs of a hardware root of trust are relatively high. Low-end or old hardware platforms do not support a hardware root of trust. Cloud technologies often make use of heterogeneous hardware platforms. The different hardware platforms in the cloud may make use of different kinds of hardware root of trust or may not support any kind of hardware root of trust. It is therefore difficult to make use of traditional hardware root of trust to protect data in the cloud with heterogeneous hardware platforms. Hardware roots of trust are not well suited to container orchestration technologies, such as Kubernetes (which is an open-source container orchestration system originally designed by Google and currently maintained by the Cloud Native Computing Foundation). Container orchestration technologies automatically distribute the storage and processing of data throughout the hardware platforms in the cloud. Traditional secret storage technology based on a hardware root of trust is bound to a specific hardware device. Once the container orchestration technology schedules the data to another hardware device, the secret data can no longer be accessed.

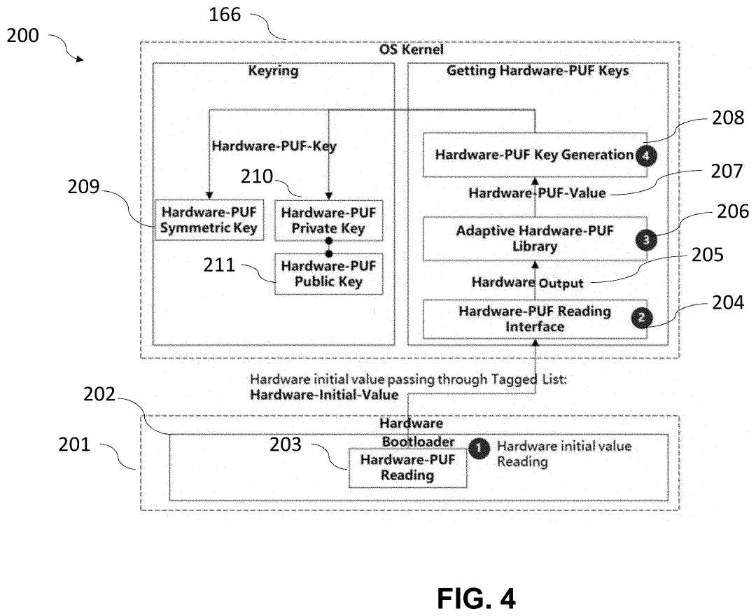

Reference is now made to FIG. 4, which shows a schematic diagram for generating a hardware PUF key 200, according to some embodiments of this disclosure. The hardware source 201 may be a static random-access memory (SRAM), a dynamic random-access memory (DRAM), a FPGA, an ARM® processor, an X86 processor, a RISC processor, a graphics processing unit (GPU), a data processing unit (DPU), a neural-network processing unit (NPU), a microcontroller unit (MCU), a system on a chip, an application specific integrated circuit, or other programmable circuit. The hardware source 201 may be any other type of hardware capable of providing a PUF. The bootloader 202 may contain a hardware PUF reading module 203. The hardware PUF reading module 203 reads the hardware source 201 to obtain a unique hardware output 205 of the hardware source 201 that serves as a unique identifier of the hardware source 201. The hardware source 201 may provide a PUF to generate the hardware output 205. A PUF is a physical function of a hardware device that, given an input, provides an output with a physically determined fingerprint unique to the hardware source 201. PUFs may be based on unique physical variations that arise during manufacturing. The unique hardware output 205 is unique to the hardware source 201 because the unique hardware output 205 results from random physical factors in the microstructure of the hardware source 201 that arise naturally during manufacturing. Given the same input, the PUF of the hardware source 201 will generate the same output. Given the randomness of the physical factors, no two hardware sources will generate the same output. Consequently, the unique hardware output 205 can serve as a unique identifier of the hardware source 201. For example, the unique hardware output 205 may be the initial power-on value of the hardware source 201, such as SRAM or DRAM, which the hardware PUF reading module 203 reads when the computer device 102/104 starts up. As another example, the PUF may be a butterfly PUF of an FPGA. The PUF may be any other known PUF. The hardware PUF reading module 203 or another component of the bootloader 202 may pass the unique hardware output 205 to the operating system 166, and more specifically to the kernel of the operating system 166. For example, the hardware PUF reading interface 204 of the operating system 166 may receive the hardware output 205 from the hardware PUF reading module 203.

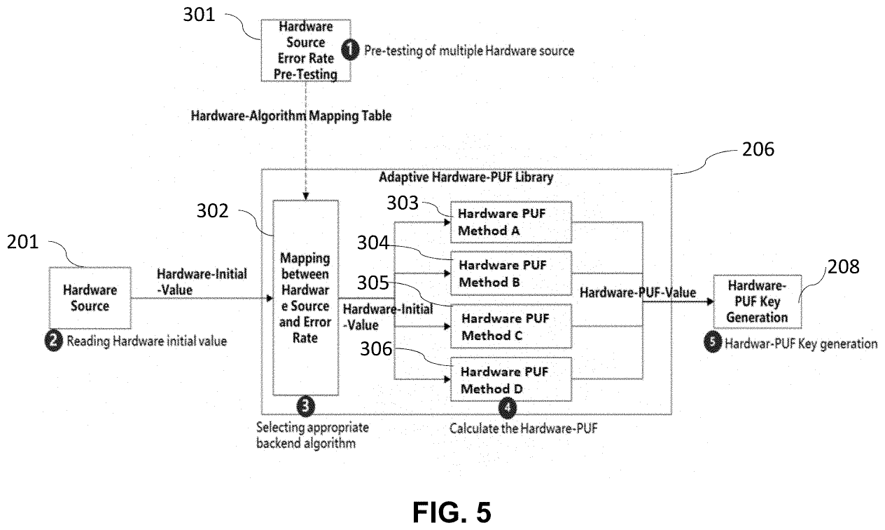

Reference is now made to FIG. 5, which shows schematic diagram of the adaptive hardware PUF library 206, according to some embodiments of the present disclosure. The adaptive hardware PUF library 206 calculates the hardware PUF value 207 based on the hardware output 205. The adaptive hardware PUF library 206 may receive the hardware output 205 from the hardware PUF reading interface 204, or in any other manner directly or indirectly from the hardware source 201. The adaptive hardware PUF library 206 comprises a plurality of PUF methods, for example but not limited to, 303, 304, 305, 306, for calculating the hardware PUF value 207. In these embodiments, the adaptive hardware PUF library 206 comprises four PUF methods 303, 304, 305, 306. However, the adaptive hardware PUF library 206 may comprise any number of such PUF methods. The adaptive hardware PUF library 206 calculates the hardware PUF value 207 by selecting one of the plurality of hardware PUF methods 303, 304, 305, 306, each of the plurality of hardware PUF methods 303, 304, 305, 306 adapted to a respective hardware source type. Each of the hardware PUF methods 303, 304, 305, 306 is adapted to process the hardware output 205 of a different type of hardware source 201. The hardware PUF methods 303, 304, 305, 306 may be implemented as different software algorithms within the adaptive hardware PUF library 206. In this way, the adaptive hardware PUF library 206 may be used on a variety of different types of hardware without modification. The adaptive hardware PUF library 206 may comprise a mapping table 302 between the hardware source types and the hardware PUF methods 303, 304, 305, 306. The mapping table 302 may map the hardware source 201 to a particular hardware PUF method 303, 304, 305, 306. The bootloader 202 may detect the hardware type of the hardware source 201 and pass it to the adaptive hardware PUF library 206, and then using the mapping table 302 determine which hardware PUF method 303, 304, 305, 306 should be used to process the hardware output 205. That is, the adaptive hardware PUF library 206 automatically detects a hardware type of the hardware source 201, and the selected hardware PUF method 303, 304, 305, 306 is selected based on the hardware type. If the hardware source 201 is not in the mapping table, then a default hardware PUF method 303, 304, 305, 306 may be used. The hardware PUF method 303, 304, 305, 306 may be selected by a user, for example in a settings or configuration file.

For example, the selected hardware PUF method 303, 304, 305, 306 may be selected based on the hardware types and indications of the hardware types stored in the mapping table 302, for example based on an error rate of the hardware type, and the error rate of the hardware type is stored in the mapping table 302. A hardware error rate testing tool 301 may be used to test the error rates of different hardware types prior to runtime in order to build the mapping table 302. Alternatively, the adaptive PUF library 206 may run the hardware error rate testing tool 301 at runtime to determine the error rate of the hardware source 201. Each hardware PUF method 303, 304, 305, 306 may be adapted to a different error rate. For example, hardware PUF method 303 may have an error tolerance of less than 10%, hardware PUF method 304 may have an error tolerance of less than 20%, hardware PUF method 305 may have an error tolerance of less than 30%, and hardware PUF method 306 may have an error tolerance of less than 40%. If it is not possible to determine the hardware type or the error rate of the hardware type, then the hardware PUF method 303, 304, 305, 306 with the greatest error rate recovery (or error tolerance) may be selected by default. For example, the hardware PUF method 306, which can tolerate an error rate up to 40%, may be selected.

The output of the adaptive hardware PUF library 206 is the hardware PUF value 207, which is then provided as input to the hardware PUF key generation module 208. The hardware PUF key generation module 208 may generate a PUF key using the selected hardware PUF method 303, 304, 305, 306, and in particular using the hardware PUF value 207. The hardware PUF key generation module 208 may generate a PUF symmetric key 209. The hardware PUF key generation module 208 may generate a PUF asymmetric key pair 210 and 211 comprising a private key 210 and a public key 211. The PUF key may comprise the PUF symmetric key 209 and the PUF asymmetric key 210, 211. The PUF asymmetric key 210, 211 may comprise the public key 210 and the private key 211. The PUF key 209, 210, 211 may be passed to a key management service, such as a keyring. The PUF key 209, 210, 211, and in particular the PUF symmetric key 209 may be used to securely store local user data. For example, the data may be securely stored on the storage device 126 of computing device 102/104.

The hardware source 201 may be internal to the computer device 102/104. For example, the hardware source 201 may be internal memory 126 or a processor 122 of the computing device 102/104. The hardware source 201 may also be an internal graphics processing unit of the computing device 102/104. Alternatively, the hardware source 201 may be external to the computer device 102/104. The hardware source 201 may be external SRAM, DRAM, or an FPGA connected to the hardware source 201 through USB or a PCI express channel.

The PUF asymmetric key 210, 211 may be used to securely communicate with a remote computer on a computer network 108. For example, a client computing device 104 may communicate securely over the network 108 with another client computing device 104 or with a server computing device 102. Different secure communication protocols may be used, such as Transport Layer Security (TLS) or Secure Socket Layer (SSL). The PUF asymmetric key 210, 211 may be used to encrypt the date communicated over the network 108 to prevent third parties from accessing the data and to certify the identity of the computes or users. The PUF asymmetric key 210, 211 may be used to generate a device certificate for device authentication, such as a TLS certificate.

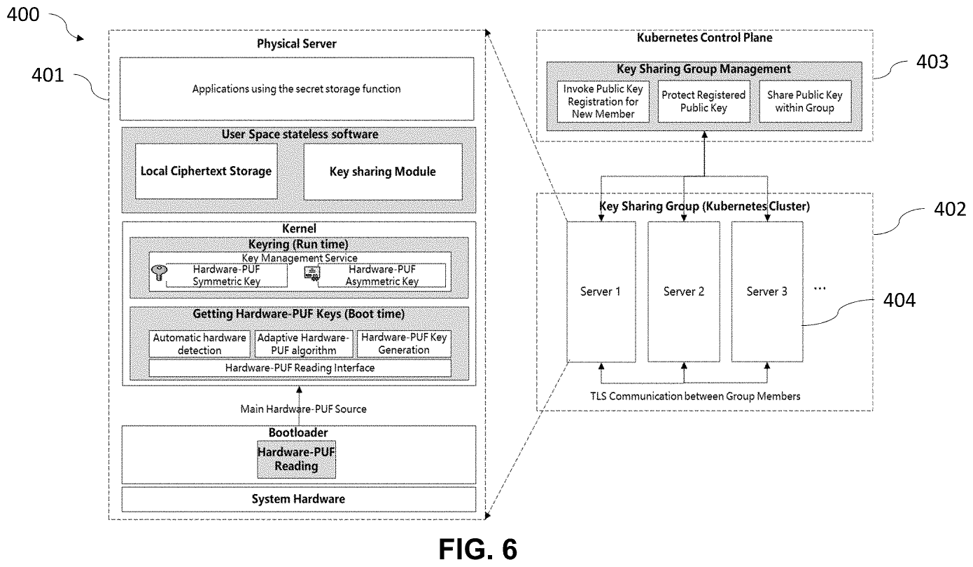

Reference is now made to FIG. 6, which shows a schematic diagram for a secret sharing group 400. The PUF asymmetric key 210, 211 may further be used to create or join a secret sharing group 402 comprising a plurality of computers. Secret sharing refers to different methods for distributing a secret (such as data) among a group of computers 402. Each computer in the group 402 is provided with only a part of the secret. In order to recover the secret, a certain minimum number of parts is required. It is not possible to recover the secret with only a single part. Secret sharing is a distributed way to securely store data. The adaptive hardware PUF library 206 is well suited to securely storing data in a heterogeneous secret sharing group 402. Since the adaptive hardware PUF library 206 has different PUF methods 303, 304, 305, 306 adapted to difference types of hardware sources 201, the adaptive hardware PUF library 206 can be deployed on a variety of different computing devices in the group 402. This enables deploying the secret sharing group 402 on heterogeneous hardware that do not require a hardware root of trust. Moreover, combining the security from encrypting data using the PUF key 209, 210, 211 with the added security of secret sharing, a high level of data security can be achieved without expensive hardware or a hardware root of trust.

In some embodiments, Kubernetes may be used to manage the secret sharing group 402. For example, a Kubernetes control pane 403 may be used to store the public keys 211 of the computers in the group 402 and to manage computers joining the group 402.

A computer 401 may use the PUF key 209, 210, 211 and the secret sharing group 402 to securely store data. The computer 401 may encrypt the data using an encryption key to produce cipher text A. In particular, the computer 401 may encrypt the data using the PUF symmetric key 209. The computer 401 may make a secret sharing request to a secret sharing module on the computer 401. The secret sharing module may generate a random encryption key K. The encryption key K may be used to further encrypt the cipher text A to produce cipher text C. The secret sharing module may then split the encryption key K using a secret sharing method into a plurality of, for example a number “m”, encryption key parts, i.e. m is the number of encryption key parts. In some embodiments, the number of encryption key parts m may for example be equal to or less than the number of computers in the secret sharing group 402. Likewise, the secret sharing module may split cipher text C into a number of parts. The computer 401 sends the encryption key parts to the plurality of computers in the secret sharing group 402. The computer 401 also sends the cipher text C parts to the plurality of computers in the secret sharing group 402. The communication of the encryption key parts and the cipher text C parts may be through secure channels using the PUF asymmetric key 210, 211.

A computer 404 of the secret sharing group 402 receives the encryption key part from a remote computer 401 of the plurality of computers in the secret sharing group 402. The computer 404 also receives the cipher text C part from a remote computer 401. The computer 404 encrypts the encryption key part using its PUF symmetric key 209, and further encrypts the cipher text C part using its PUF symmetric key 209. The computer 404 may store the encrypted encryption key part and the cipher text C part on its local storage 126.

The computer 401 may retrieve one or more of the plurality of, for example a number “n”, encryption key parts and the cipher text C parts from the plurality of computers in the secret sharing group 402, i.e. n is the number of encryption key parts retrieved by the computer 401. The number of encryption key parts n retrieved may be less than the number of original encryption key parts m. This may occur, for example, because some of the computers in the secret sharing group 402 are offline. The computer 404 may then receive a request for the encryption key part and the cipher text C part from the remote computer 401. The computer 404 may then retrieve the encryption key part and the cipher text C part from local storage 126. The computer 404 may then decrypt the encryption key part and the cipher text C part using its PUF symmetric key 209. The computer 404 may then send the encryption key part and the cipher text C part over the secure network 108 to the remote computer 401. The computer 401 may then combine the encryption key parts and the cipher text C parts to recover the encryption key K and the cipher text C using the secret sharing method of a secret sharing module. In some embodiments, the computer 401 may be able to combine the n encryption key parts and cipher text C parts to recover the encryption key K and the cipher text C even if n is less than m, if n is greater than a threshold, which is the minimum number of encryption key parts required to combine the encryption key K and may be set by the computer 401 or be predefined in the PUF library. That is, not all of the original encryption key parts m are required to recover the encryption key K and the cipher text C. The computer 401 may then decrypt the data using the encryption key. That is, the computer 401 may then decrypt the cipher text C using the encryption key K to obtain the cipher text A. The computer 401 may further decrypt cipher text A using the computer's 401 PUF symmetric key to obtain the original data.

While the disclosure has been described in connection with specific embodiments, it is to be understood that the disclosure is not limited to these embodiments, and that alterations, modifications, and variations of these embodiments may be carried out by the skilled person without departing from the scope of the disclosure. It is furthermore contemplated that any part of any aspect or embodiment discussed in this specification may be implemented or combined with any part of any other aspect or embodiment discussed in this specification.

1. A method for generating a physical unclonable function (PUF) key, comprising:
obtaining a hardware output of a unique identifier of a hardware source by reading the hardware source;
selecting one of a plurality of hardware PUF methods, each of the plurality of hardware PUF methods adapted to a respective hardware source type; and
generating the PUF key based on the hardware output using the selected hardware PUF method.

2. The method of claim 1, further comprising detecting a hardware type of the hardware source, wherein the selected hardware PUF method is selected based on the hardware type.

3. The method of claim 2, wherein an indication of the hardware type is stored in a mapping table.

4. The method of claim 3, wherein the selected hardware PUF method is selected based on an error rate of the hardware type, wherein the error rate is stored in the mapping table.

5. The method of claim 4, wherein the plurality of hardware PUF methods comprise a first hardware PUF method with an error tolerance of less than a first threshold, a second hardware PUF method with an error tolerance of less than a second threshold, a third hardware PUF method with an error tolerance of less than a third threshold, and a fourth hardware PUF method with an error tolerance of less than a fourth threshold.

6. The method of claim 5, wherein the first, second, third, and fourth thresholds are 10%, 20%, 30%, and 40%, respectively.

7. The method of claim 5, wherein the fourth threshold is greater than each of the first, second, and third thresholds; and wherein the selected hardware PUF method is the fourth hardware PUF method if the hardware type is not detected.

8. The method of claim 1, wherein the selected hardware PUF method is selected by a user.

9. The method of claim 1, wherein the hardware output is an initial power-on value of the hardware source.

10. The method of claim 1, further comprising passing the PUF key to a key management service.

11. The method of claim 1, wherein the PUF key comprises a PUF symmetric key and a PUF asymmetric key, wherein the PUF asymmetric key comprises a public key and a private key.

12. The method of claim 11, further comprising using the PUF symmetric key to securely store local user data.

13. The method of claim 11, further comprising using the PUF asymmetric key to securely communicate with a remote computer on a computer network.

14. The method of claim 11, further comprising using the PUF asymmetric key to join a secret sharing group comprising a plurality of computers.

15. The method of claim 14, further comprising:
encrypting data, by a first computer in the secret sharing group, using an encryption key;
splitting, by the first computer in the secret sharing group, the encryption key using a secret sharing method into a plurality of encryption key parts; and
sending, by the first computer, the encryption key parts to at least one other computer of the plurality of computers in the secret sharing group;
encrypting, by the at least one other computer of the plurality of computers in the secret sharing group, the encryption key part using the PUF symmetric key.

16. The method of claim 15, further comprising:
decrypting, by the at least one other computer of the plurality of computers in the secret sharing group, the encryption key part using the PUF symmetric key;
retrieving, by the first computer, one or more of the plurality of encryption key parts from the at least one other computer of the plurality of computers in the secret sharing group;
combining, by the first computer, the encryption key parts to recover the encryption key using the secret sharing method; and
decrypting, by the first computer, the data using the encryption key.

17. The method of claim 16, wherein the first computer sends m encryption key parts, wherein the first computer retrieves n encryption key parts, wherein n is less than m, and wherein n is equal to or greater than a threshold required to recover the encryption key using the secret sharing method.

18. The method of claim 11, further comprising generating a device certificate for device authentication using the PUF asymmetric key.

19. A non-transitory computer-readable medium comprising computer program code stored thereon for generating a physical unclonable function (PUF) key, wherein the code, when executed by one or more processors, causes the one or more processors to perform a method comprising:
obtaining a hardware output of a unique identifier of a hardware source by reading the hardware source;
selecting one of a plurality of hardware PUF methods, each of the plurality of hardware PUF methods adapted to a respective hardware source type; and
generating the PUF key based on the hardware output using the selected hardware PUF method.

20. A computing device comprising one or more processors operable to perform a method for generating a physical unclonable function (PUF) key, wherein the method comprises:
obtaining a hardware output of a unique identifier of a hardware source by reading the hardware source to;
selecting one of a plurality of hardware PUF methods, each of the plurality of hardware PUF methods adapted to a respective hardware source type; and
generating the PUF key based on the hardware output using the selected hardware PUF method.
